(19) United States
(12) Patent Application Publication
(10) Pub. No.: US 2005/0273702 A1
(43) Pub. Date: Dec. 8, 2005

(54) Creation and management of common interest community web sites

(76) Inventor: Jeff Trabucco, San Jose, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/861,102

(22) Filed: Jun. 4, 2004

(51) Int. Cl. G06F 17/00; G06F 17/30

(52) U.S. Cl. 715/513; 707/7; 707/1; 715/501.1

(57) ABSTRACT

Systems and methods consistent with the present invention integrate content creation, content management, content display and user interaction functions for web sites. In some site management methods consistent with the present invention content may be submitted and is processed to associate the submitted content with pre-existing related content accessible through the web site. In some embodiments consistent with the present invention submissions may be prioritized for display at prominent locations on the web site.

### BACKGROUND

1. Field of the Invention

The invention relates to the field of computer software and in particular to software for the rapid creation and deployment of web sites for common interest communities.

2. Discussion of Related Art

Artsopolis™, Artsopolis Silicon Valley, Arts Council Silicon Valley, Artsopolis Marketing Partnership and AMP are marks or registered trademarks of Arts Council Silicon Valley.

The growth of the Internet has allowed millions of people access to content held on computers connected to the Internet. Software programs, termed web servers, on these computers are responsible for making content stored on the computer available to Internet users. Internet users may locate such content by using the address of the web site. Web site addresses consist of at least three parts, called domain names, each separated by a dot (“.”). The first part is usually “www” which refers to the Worldwide Web, or simply “the web,” as it is generally known. The second part is a unique name that is chosen by the web site, for example, the name of the organization displaying content on the web site. The third part of the name, called the tertiary level domain name, represents the general area or broad category to which the web site belongs. For example, commercial web sites are generally in the “.com” domain, government web sites are in the “.gov” domain and non-profit organization web sites are in the “.org” domain. The address may also contain additional parts that locate specific content, such as a file, within the web site. These portions separated by forward slashes (“/”) are appended after the tertiary level domain name. A string that specifies the protocol to be used when accessing the web site may also precede the address. For example, a string such as, “http://” specifies that the hypertext transfer protocol will be used to transfer data from the web site. The entire address that is used to locate and browse a web site is termed the Uniform Resource Locator (“URL”). Content on web sites is displayed on a user's computer by means of a software program called a web browser. The process of accessing content on a web site is called browsing. Content on the web site is typically managed by a web site administrator, who has the responsibility for updating content on the web site and ensuring the sites smooth functioning.

The popularity of a web site depends in part on the ease with which a user can access and locate content within the web site. Well-designed web sites allow Internet users access to enormous amounts of content with relative ease. On the other hand, a poorly designed site may have similar content but may be difficult to browse through, to discover and retrieve the information desired. Designing a web site to achieve the desired level of ease of use while maintaining rich data content is a complex task that may often require a substantial amount of work and fine-tuning. In addition to the task of creating a web site that presents a user-friendly interface to users, the designer of a web site must also create a mechanism for allowing content to be entered and stored in a manner that facilitates the easy navigation and retrieval of information from the web site.

In many instances, the web site is “hosted” by a third party. When a web site is hosted, a third party may provide the computers and network connections to allow the site to be viewed over the Internet. Typically, parties that host web sites may have high bandwidth network connections and faster computers, which are shared between several hosted sites allowing for cost savings. Moreover, a web hosting arrangement saves the web site owner from having to invest in and routinely upgrade and maintain hardware. Hosting arrangements are therefore quite commonplace. Hosting arrangements, however, involve additional considerations for a web site designer or creator because web site updates may need to be performed remotely from another computer, rather than locally from the computer on which the content resides. This may involve the creation of additional software to allow the tasks of maintaining the web site to be performed remotely.

The cumulative effect of all of the considerations described above may result in a substantial time lag between the conceptualization of a web site and its actual realization and also involve considerable expense in developing web sites for a particular application.

Web sites developed for common interest communities, for example, typically include content directed towards events or other information of interest to that community. However, the level of content required to service the entire community can be too overhead intensive to allow for a functional and easily accessible site. Most such sites are in the form of chat rooms, message boards, “blogs,” or web sites directed towards one type of activity and are not directed to a wide variety of activities that may be of interest to the community. Maintaining the level of content required to adequately service a common interest community is typically beyond the usual capabilities of such sites. For example, a message board based site may include discussion of a particular activity, but sufficient detail regarding that activity may not be presented. Further, data obtained from many sites, for example a message board, is not necessarily monitored and may not be entirely reliable. Further, data regarding activities may be too slow to disperse, causing announcements of activities to occur too late for participation by interested members of the community.

Therefore there is a need for systems and methods to allow for the seamless creation, publication, and deployment of web sites for content-rich, inter-related data such as may arise with sites directed towards common interest communities.

### SUMMARY

In accordance with the present invention, a web site creation and management system for common interest communities is presented. A web site creation and management system according to some embodiments of the present invention includes a method, comprising: storing information regarding at least one activity of a community of common interest into a record of a database; prioritizing the at least one activity for display; composing a web page with the at least one activity; and displaying the web page to a user.

In some methods for web site creation and management consistent with the present invention, users are provided with a template to select from or enter data regarding an activity into a record in a database. In some embodiments consistent with the present invention, the entered data may be associated with other activities or related entities prior to being stored in the database. In some embodiments consistent with the present invention, the stored record may be prioritized for display on a web page. In some embodiments consistent with the present invention, the record stored in the database along with associated activities and entities may be used to compose a web page that may be displayed on a browser. In some embodiments consistent with the present invention, images or other multimedia content associated with the record may be displayed in conjunction with the display of the web page. In some embodiments consistent with the present invention, messages or banners related to the retrieved record may be displayed on the web page. In some embodiments consistent with the present invention, links on the displayed page may include links to electronic commercial services related to the retrieved record.

These and other embodiments are explained further with respect to the following figures.

### BRIEF DESCRIPTION OF THE DRAWINGS

FIG. 1 shows a diagram of the interaction between web site manager software and other elements in accordance with some embodiments of the present invention.

FIG. 2 shows an exemplary computer system capable of performing the web manager software function according to some embodiments of the present invention.

FIG. 3 shows a flow chart depicting an exemplary method for performing front end user content entry consistent with some embodiments of the present invention.

FIG. 4 shows a flow chart depicting an exemplary mechanism for back-end administrative content management consistent with some embodiments of the present invention.

FIG. 5 shows a flow chart depicting an exemplary method to display content to users consistent with some embodiments of the present invention.

FIG. 6 shows a flow chart depicting an exemplary method to display content relating to a particular category (events) consistent with some embodiments of the invention.

FIG. 7A shows an exemplary template for a displayed web page used to create a web home page for viewing on a browser retrieving information from an exemplary arts and cultural common interest community consistent with some embodiments of the invention.

FIG. 7B shows an example of a displayed web page according to the template shown in FIG. 7A consistent with some embodiments of the present invention.

FIGS. 8A and 8B show sections of an exemplary web page for Front End User Event Entry consistent with some embodiments of the present invention.

FIG. 8C shows an exemplary web page that presents all pending front end user record submissions for approval by administrators consistent with some embodiments of the present invention.

FIG. 8D shows an exemplary web page that presents all pending front end user record submissions for a particular event category for approval by administrators consistent with some embodiments of the present invention.

FIGS. 9A, 9B, and 9C show an exemplary web page for back end administrative content entry that may be used for submitting and approving content listings consistent with some embodiments of the present invention,

FIGS. 10A and 10B show a web page that serves as a template manager for a common interest community organization home page consistent with some embodiments of the present invention.

FIG. 11 shows an exemplary web page that serves as a template manager for an event category page consistent with some embodiments of the present invention.

In the figures, elements having the same designation have the same or similar functions.

### DETAILED DESCRIPTION

In accordance with the present invention, methods and systems are provided for the creation, publication and maintenance of web sites for common interest communities. In web sites that present content to a community of interested users, termed a common interest community, such as an arts and cultural web site, the variety of offerings and the inter-relationships between various data elements make the management of content extremely complex. Typically, such content management involves the use of databases. A web site creator must be able to design and normalize data stored in the database to allow for its efficient retrieval. However, the data as stored may not always correspond to the logical or conceptual categories as seen by users. For example, the data may be stored in multiple tables and the data resident in these tables may need to be “stitched” together before it can be presented to users. This may require the use of additional programs and software. Finally, the database, application elements and other software must all be integrated so that they work together as one unit in a manner that is transparent to Internet users on one hand and to the administrators of the web site on the other.

In some methods for creating, publishing, and managing web sites for common interest communities, predefined categories are provided in a database corresponding to categories of interest for a common interest community. In some methods consistent with the present invention, a web site creator can select or create categories of interest and enter data related to the content to be provided on the web site. In some methods consistent with the present invention, relationships between inter-related categories and/or content entered are automatically recognized by the software and translated into appropriate links on the web site. In some methods consistent with the present invention, a software interface allows web site users to browse, search for, and retrieve data contained in the published web site or to receive automatic content updates related to specified areas of interest. In some embodiments consistent with the present invention, users may submit new content, related to categories displayed on the web site that is entered into the database and may be automatically reflected on the web page.

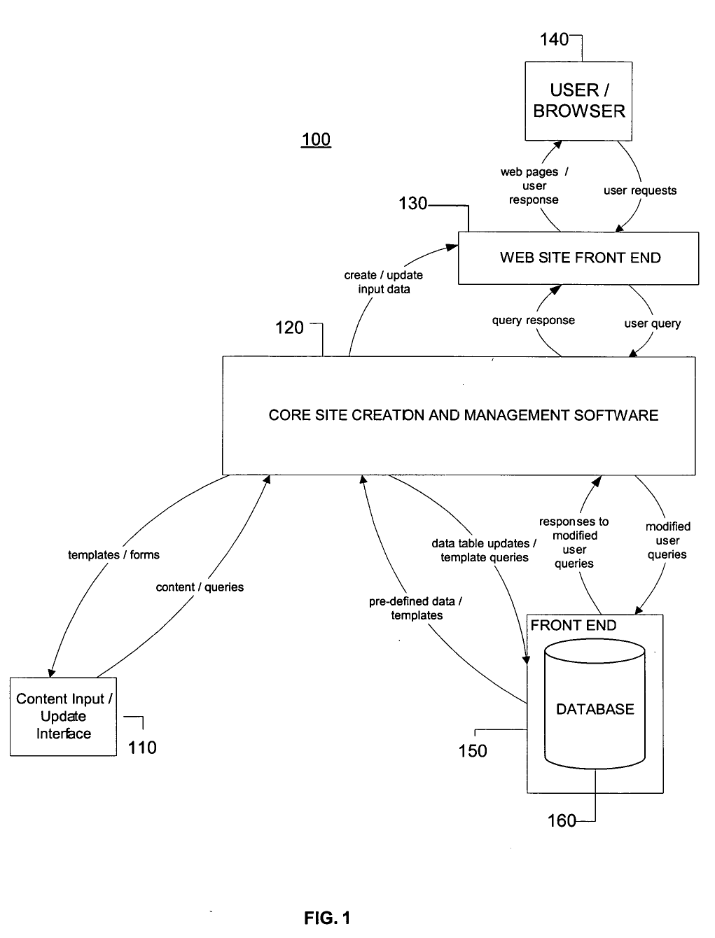

FIG. 1 illustrates the interaction between the various elements in an exemplary system 100 for web site creation, publication and maintenance consistent with some embodiments of the present invention. As shown in FIG. 1, system 100 includes a Core Site Creation and Management Software 120 that communicates with a Content Input/Update Interface 110 and a Database Front End 150, which interacts directly with Database 160. Database Front End 150 can accept and processes requests related to management of database 160. In some embodiments consistent with the present invention, Core Site Creation and Management Software 120 can exchange information with a Web Site Front End 130, which interacts with web site users through their Browsers 140.

In some embodiments consistent with the present invention, the Content Input/Update Interface 110 presents templates and pre-defined data stored in database 160 to a web site designer (not shown) in response to input from the site designer. In some embodiments consistent with the present invention, Content Input/Update Interface 110 can send input from the designer to Core Site Creation and Management Software 120 where that input may be translated into queries for a Database Front End 150 to retrieve the appropriate templates and pre-defined data from database 160. The retrieved information can be passed to Content Input/Update Interface 110 and displayed to the site designer. In some embodiments consistent with the present invention, as shown in FIG. 1, Content Input/Update Interface 110 can also accept input, which can be passed to Core Site Creation and Management Software 120, for generating requests to the database front end 150 to update existing information in database 160 and/or to add new content or templates to database 160.

In some embodiments, Core Site Creation and Management Software 120 can merge content stored in database 160 with designer selected templates and input to generate data for web page creation by a Web Site Front End 130. Web site users can interact with Web Site Front End 130 through Browsers 140 to view and access content stored on the web site. In some embodiments consistent with the present invention, Web Site Front End 130 can process user requests and generate information to update views of the site through browser 140. User requests that require information from database 160 can be transmitted to Core Site Creation and Management Software 120. Such requests can be transformed into modified user queries that are appropriate database queries that can be processed by Database Front End 150 to retrieve information from database 160. Responses received by Core Site Creation and Management Software 120 from Database Front End 150 are processed to create a response to the user query which is then sent to Web Site Front End 130 to generate browser updates for browser 140.

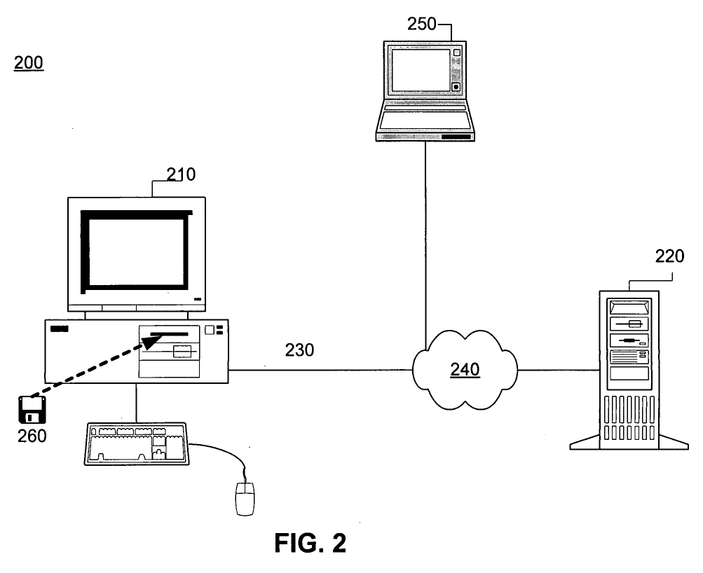

FIG. 2 illustrates an exemplary computing system 200 capable of performing methods consistent with the present invention. In some embodiments, a computer software application that includes embodiments of the present invention may be deployed on a network of computers, as shown in FIG. 2, that are connected through communication links 240 that allow information to be exchanged using conventional communication protocols and/or data port interfaces. As shown in FIG. 2, system 200 includes a computing device 210 with removable storage media 260, a server 220, and a browsing device 250. Further, computing device 210 and server 220 may communicate over a connection 230, which may pass through network 240. Computing device 210 may be a computer workstation, desktop computer, laptop computer or any other computing device capable of being used in a networked environment. Server 220 may be a platform capable of connecting to computing device 210.

Connection 230 couples computing device 210 and server 220. Connection 230 may be implemented as a wired or wireless connection using conventional communication protocols and/or data port interfaces. In general, connection 230 can be any communication channel that allows transmission of data between computing device 210 and server 220, including network channels and transfer of data between machines on fixed storage media. In some embodiments, for example, both computing device 210 and server 220 may be provided with conventional data ports for transmission of data through the appropriate connection 230. Further, computing device 210 and server 220 can include removable medium 260, which can be a floppy disk, RAM disk, Zip drive, or other such device, for storing programs and data, including embodiments of the present invention. Network 240 can, for example, include a Local Area Network (LAN), a Wide Area Network (WAN), or the Internet. Browsing device 250 can, for example, be a computer, laptop, handheld computer or any device that allows a user to browse web pages. Browsing device 250 can access content on server 220 through network 240. Communication links 240 can be wireless links or wired links or any combination consistent with embodiments of the present invention that allows communication between computing device 210, browsing device 250 and server 220. Embodiments of the present invention may be stored in computing device 210 or server 220, either in non-volatile memory devices or hard drives. Further, computer code including embodiments of the present invention can be stored on removable medium 260.

In some embodiments consistent with the present invention, database 160, database front end 150, Core Site Creation and Management Software 120 and Web Site Front End 130 of FIG. 1 can reside on server 220. In some embodiments consistent with the present invention Content Input/Update Interface of FIG. 1 could reside on computing device 210 of FIG. 2 and browser 140 of FIG. 1 could reside on browsing device 250 of FIG. 2. It should be noted that the portrayal above in which elements of the system of FIG. 1 are described as being resident on various devices in FIG. 2 are exemplary and illustrative only and do not limit the invention. One skilled in the art will appreciate that the elements of the system may be deployed differently, in a manner consistent with the invention, to achieve the purposes of the invention.

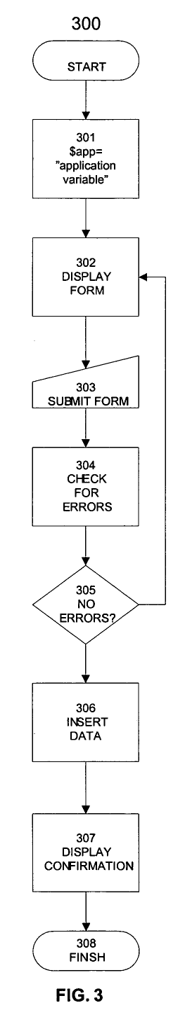

FIG. 3 shows a flow chart depicting an exemplary method for front end user content entry of web site front end 130 and core site creation and management software 120 consistent with some embodiments of the present invention. In some embodiments consistent with the present invention, common interest community users, i.e. people being served by the common interest community web site, may directly input data into a form for eventual entry into the database 160 of FIG. 1. In step 301, variables are generated from the URL of the web page being navigated by the front end user. In step 302, the variables generated in step 301 are used to present the front end user with a form for content entry. In some embodiments, individual web pages can be generated for each function and that page can be loaded when required. In some embodiments consistent with the present invention, forms corresponding to pre-existing user defined categories of interest are stored in the database. Data entered on the form may be submitted in step 303 and checked for errors or conflicts in step 304. In some embodiments consistent with the present invention, if no errors or conflicts are present, data from the form may be entered into the database in step 305, and a confirmation displayed to the front end user in step 307. In some embodiments consistent with the present invention, data submitted by a front end user may be stored temporarily in a pending database, for subsequent editing and processing prior to updating the database. In some embodiments consistent with the present invention, front-end user entered content may be entered into database 160 of FIG. 1, on an automated schedule. In some embodiments consistent with the present invention, front-end user entered content may be submitted for approval to a site administrator prior to entry into the database 160 of FIG. 1.

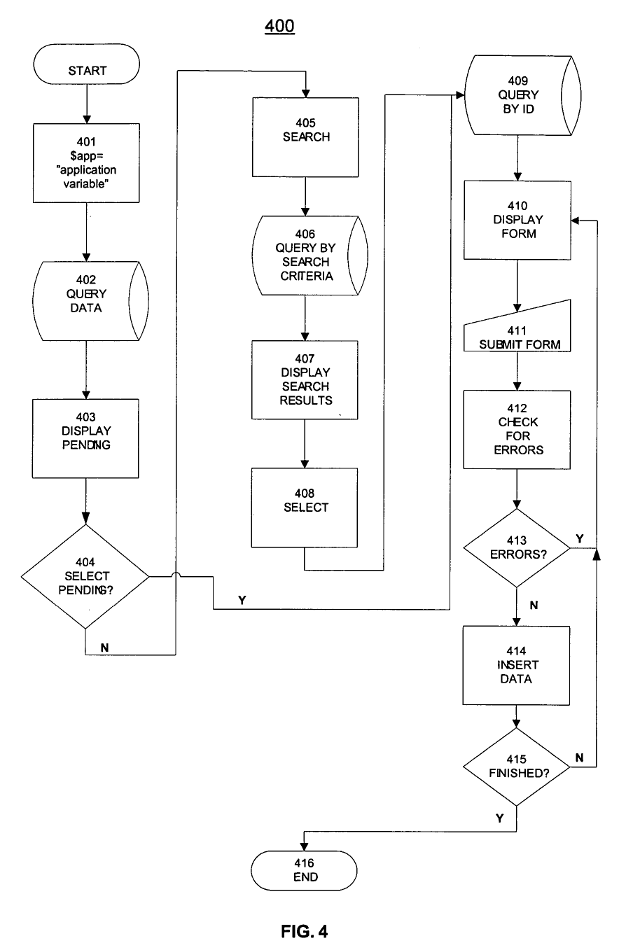

FIG. 4 shows a flow chart depicting an exemplary mechanism for back-end administrative content management of content input/update 10 and core site creation 120 consistent with some embodiments of the invention. In some embodiments consistent with the present invention the administrative back-end management system allows content to be entered for storage in appropriate tables in the database. In some methods for administrative back-end management consistent with the present invention, the back end administrator loads an administrative form in a web browser to input new content into database 160 or update and retrieve existing data in database 160. In step 401, the type of record being edited is determined by a variable that is passed through the page URL and the editing form is displayed with text and drop down data fields for the user to type in or select data. In some embodiments data fields contained in the forms determine the links displayed or actions performed when the web page associated with the form is viewed. Based on the type of data that a back end administrator is entering, the database may be queried for pre-existing pending instances of such data in step 402. In some embodiments, those previous entries, if found, can be such pre-existing pending data as may exist as a result of front end user content submissions, as shown in FIG. 3. A back end administrator may select one of the displayed pending instances for updating in step 404. For example, for a common interest arts community, a back end administrator may select from pending arts performances awaiting submission to the database. To ensure that the database is not populated with duplicate instances of the same data, the user may use search criteria in step 405, to check if the database already has an identical entry. The search criteria are used to generate a new query in step 406. For example, arts performances within a certain geographic area may be searched. Data retrieved in response to the search criteria query is displayed in step 407, and a back end administrator may select from the displayed data in step 408. Once data has been selected in step 408, the user may query the database for records that are already associated with the selected data in step 409. For example, the database may be queried to locate a selected arts performance event and its associated attributes, once it has been selected from the results displayed in response to a search criteria query.

If data cannot be located in response to the back-end administrator's searches, new data may be entered into the form. The completed form with back end administrator input and/or selected data is displayed in step 410 and is submitted for entry into appropriate tables in the database in step 411. The data is checked for integrity in step 412. If no errors are found in step 413, error-free data is inserted into the database in step 414. If the data entered into the form is found to contain errors in step 413, that form is presented to the back end administrator for error correction. In some embodiments consistent with the present invention, hyperlinks on a web page associated with the form may be automatically generated by the Core Site Creation and Management Software 120 of FIG. 1 based on the back end administrator selections for the data fields associated with the submitted form and entered into the database. The data entry process is repeated until all data has been entered. The user may then make a selection in step 415 that allows the program to be terminated in step 416. In some embodiments consistent with the present invention the images or other multi-media content may be associated with the data entered or selected or retrieved from the database. In some embodiments consistent with the present invention, links to such multi-media content may be automatically generated on the web page associated with the form by the Core Site Creation and Management Software 120 of FIG. 1. In some embodiments consistent with the present invention selection of a commerce attribute for association with data that is entered and/or selected may create a link for the direct purchasing of commercial services associated with the data. In some embodiments consistent with the present invention selection of a commerce attribute for association with data that is entered and/or selected may create a link to a third party vendor of such commercial services and/or products. In some embodiments consistent with the present invention, selection of a message attribute for association with the data will allow targeted messages to be displayed on the web page associated with the form. In some embodiments of the present invention the administrative back-end management system may be part of the Content Input/Output Interface 110 of FIG. 1.

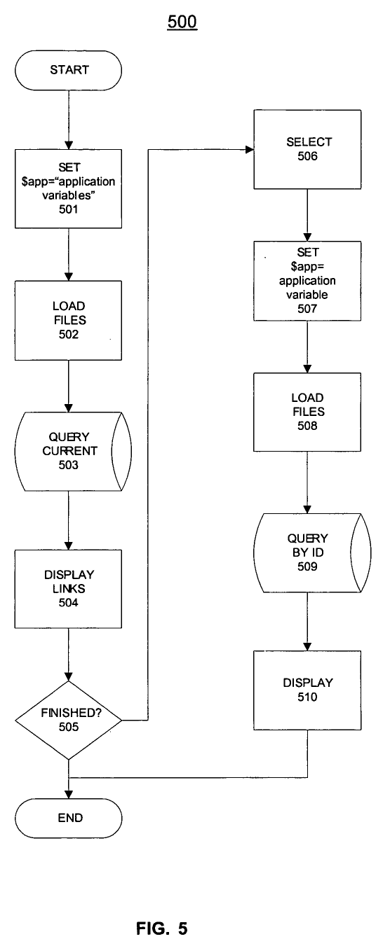

FIG. 5 shows a flow chart depicting an exemplary method to display content to front end users of core site creation 120 and web site front end 130 consistent with some embodiments of the invention. In step 501, a variable based on the URL determines the files required for display of the web page. These files may be loaded in step 502. Next, in step 503, database 160 is queried for records that pertain to the content area of interest to the front end user. The area of front end user interest may also be determined from the URL-based variable. In some embodiments consistent with the present invention additional queries may be made in step 503 to retrieve additional records associated with the first set of retrieved records. In the context of a common interest arts community for example, a single event record can be associated with an organization directory record, a venue directory record, an individual participant record, and a record representing a group of participants related to the event. Specifically, in the context of a common interest community centered on music, a performance (event) can be associated with a local community orchestra (organization), a community center (venue), a member musician (participant), and a group of member musicians (group of participants). It should be noted that the above description and examples are for illustration only and one skilled in the art will understand that such relational associations may be applicable and transferable to a broad range of community activities including music, theater, dance, art, sports, politics, clubs, and other types of associations.

In step 504, the web page with the appropriate records and links is displayed based on customized templates. In some embodiments consistent with the present invention, certain records, relevant to the area of interest, may be prioritized for display at prominent locations on the web page such as in a spotlight or a feature display box. In some embodiments consistent with the present invention, links may be created on the web page based on attributes associated with the prioritized (or spotlighted) records that then can be displayed on the web page. In some embodiments, records can be prominently displayed as a “spotlighted” record or can be displayed as “featured” records in addition to normal display of records.

In some embodiments, prioritization can be determined by a system administrator. However, absent input from the system administrator, prioritization can occur automatically according to criteria previously established for display prioritization (e.g., events can be prioritized according to the chronological order of events). Such an arrangement allows a Web site administrator maximum control over how events are displayed on the Web site. It allows the administrator to determine how prominently each event should be displayed on the web page, while at the same time, providing a system for letting the Web site “run itself” by relying on the default prioritization.

In step 506, a front end user may select one of the displayed records on the displayed web page. In some embodiments, the front end user can select any identifier displayed on the web page, for example a graphic link, a text link, or another URL. In step 507, the application variable is reset based on the front end user selection (e.g., the variable can be set to select an individual event record). Files required for the display of the new web page are loaded in step 508. In step 509, database 160 is queried based on an identifier associated with the record. The web page corresponding to the retrieved record is parsed for display and then displayed with all relevant links in step 510.

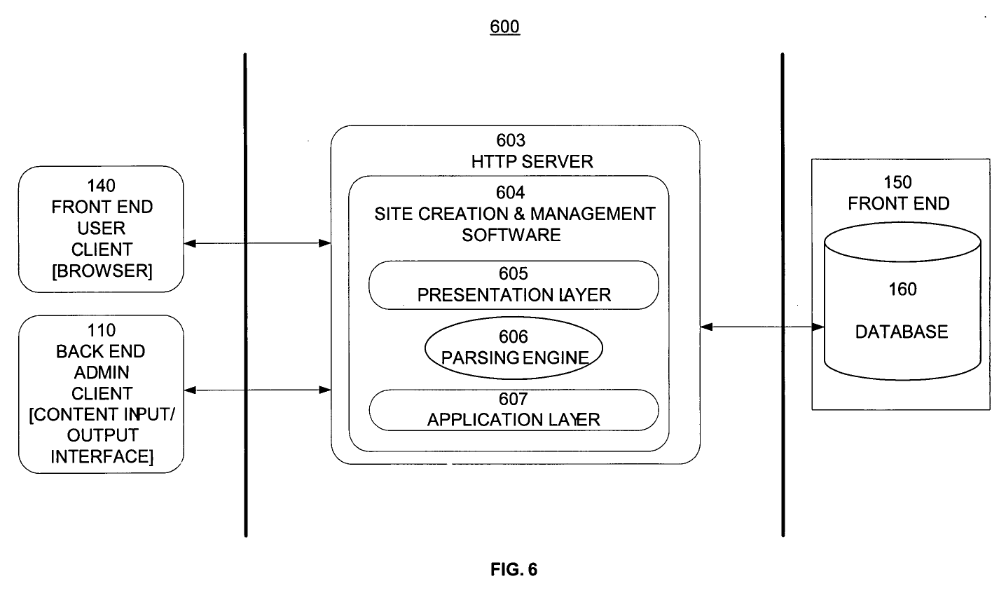

FIG. 6 is an overview of exemplary system architecture 600 for managing and presenting dynamically delivered content via the Internet. The system is comprised of a User Client 140 (front end user web browser) and an Admin Client 110 (back end administrator browser) both of which can submit and retrieve data from the Database 160 through Front End 150 via an HTTP Server 603. In some embodiments consistent with the present invention the front end user content entry may be performed using a method based on the flowchart of FIG. 3. In some embodiments consistent with the present invention, the back end administrator content entry may be performed using a method based on the flowchart of FIG. 4. Data exchanged by the User Client 140 and Admin Client 110 with the Database 160 through Front End 150 is processed by an Application Layer 607 using a Parsing Engine 606 to render web pages to front end web users and back end web administrators via a Presentation Layer 605.

In some embodiments consistent with the present invention, data submitted via User Client 140 or Admin Client 110, is passed through the HTTP Server and parsed into Database 160 using Parsing Engine 606. In some embodiments consistent with the present invention, Parsing Engine 606 may allow the creation of dynamic web pages. In some embodiments consistent with the present invention, Parsing Engine 606 may be implemented using a scripting language such as the Php Hypertext Preprocessor (“PHP”), Active Server Pages (“ASP”), Java Server Pages (“JSP”), or Cold Fusion.

In some embodiments consistent with the present invention, data in Database 160 can be retrieved through Front End 150 and displayed on a User Client 140 by using a series of content management templates controlled by Application Layer 607. In some embodiments consistent with the present invention, Application Layer 607 may include program modules of Core Site Creation and Management Software 120 of FIG. 1 that handles the application logic, database connections, and template parsing and determines the data to be displayed. In some embodiments consistent with the present invention, Application Layer 607 may pass the appropriate information including the data to be displayed and additional files, to Presentation Layer 605, which can then cause the web page to be served to User Client 140. In some embodiments consistent with the present invention Application Layer 607 may use templates to determine the placement of content on the displayed web page that is served to a User Client 140. In some embodiments consistent with the present invention, User Client 140 may reside on Browsing Device 250 of FIG. 2. In some embodiments consistent with the present invention, the Admin Client 110 may reside on Browsing Device 250 of FIG. 2. In some embodiments consistent with the present invention, HTTP Server 603, the Site Creation and Management Software 604, the Presentation Layer 605, the Parsing Engine 606 and the Application Layer 607 may reside on Server 220 of FIG. 2.

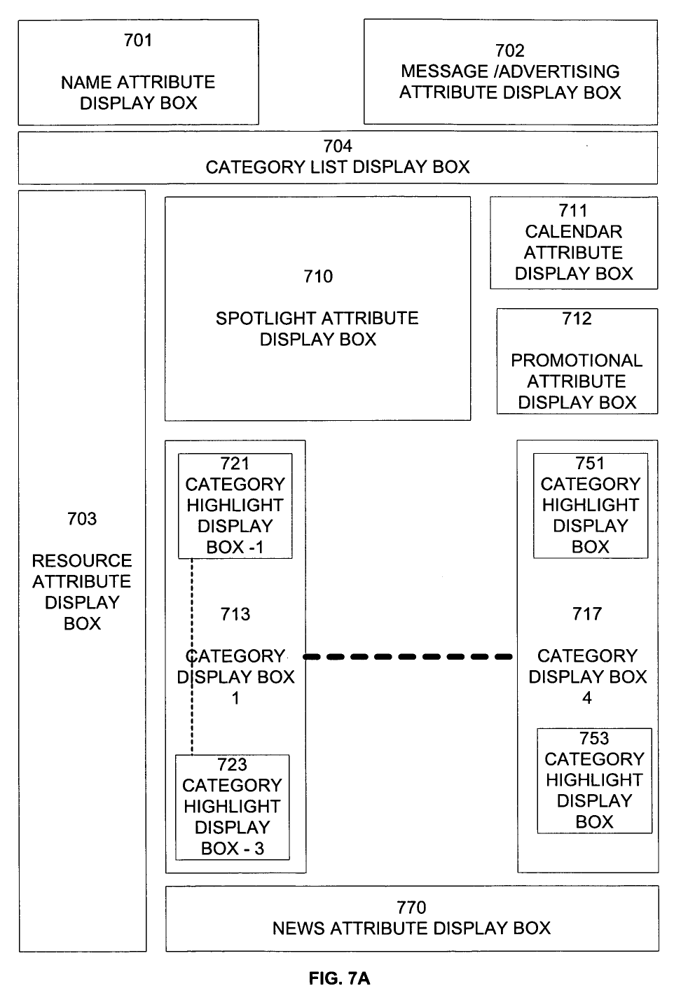

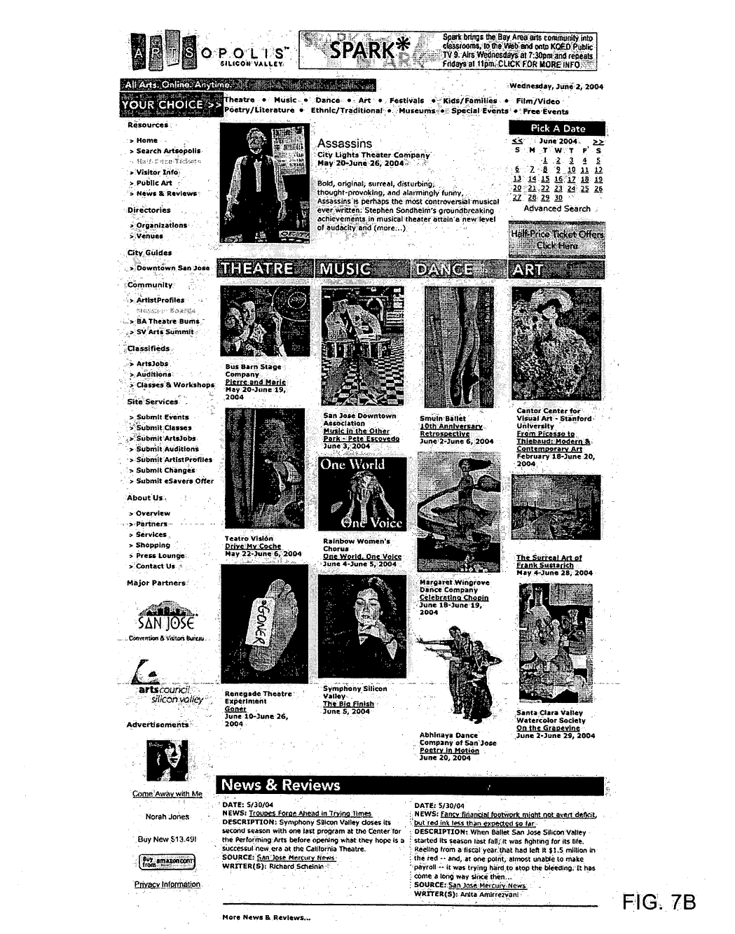

FIG. 7A shows an exemplary template for a displayed web page used to create a web home page for viewing on a browser that retrieves information from an exemplary arts and cultural common interest community. FIG. 7B shows an example of a displayed web page according to the template shown in FIG. 7A. In some embodiments consistent with the present invention, the name and/or logo(s) of the organization(s) deploying the web site may be associated with a Name Attribute and will be displayed in Name Attribute Display Box 701. A message or advertising attribute may be associated with Message/Advertising Attribute Display Box 702 for the display of messages and or advertising banners. In some embodiments resource attributes, which include links of interest to the community, may be associated with and displayed in Resource Attribute Display Box 703. In some embodiments consistent with the present invention, a Category List Display Box 704 contains links to all the categories that are associated with the common interest community. For example, in FIG. 7B, the Artsopolis™ logo appears prominently in the Name Attribute Display Box 701, a banner advertisement, such as the advertisement for the SPARK program, can appear in Message/Advertising Display Box 702 while Resource Attribute Display Box 703 includes several links of interest for the Arts Community, including Directories, City Guides and Artist Profiles. Additional categories including Festivals, Family/Children and Film/Video appear in the Category List Display Box 704.

In some embodiments consistent with the present invention, a “spotlight attribute”, may be associated with an item of interest to the community and images, descriptions and links related to the spotlighted item may appear in Spotlight Attribute Display Box 710. For example, in FIG. 7B, on an exemplary Artsopolis™ web page, a performance “Assassins” is spotlighted. In some embodiments consistent with the present invention, Calendar Attribute Display Field 711 displays a calendar of the current month. Each date on the calendar is hyperlinked to all events of interest to the community for that date. In some embodiments consistent with the present invention, when a user clicks on a particular date, a query may be generated to database 160 by Web Site Front End 130 of FIG. 1, for a search for events taking place on that date. The query and the records retrieved from database 160 may be processed by Core Site Creation and Management Software 120 and the results displayed on Browser 140. In some embodiments consistent with the present invention, promotions associated with the event may be displayed in Promotional Attributes Display Box 712. For example, in FIG. 7B, from the Artsopolis™ home page, “Half Price Ticket Offers” are displayed in the Promotional Attribute Display Box.

In some embodiments consistent with the present invention, event categories may be associated with Category Display Boxes 713 to 717. Further, events may be selected from within a specific category for highlighting in the Category Highlight Display Boxes 720 to 723 for that category. For example, FIG. 7B, taken from the Artsopolis™ home page, shows three highlighted events each under the Theatre, Music, Dance and Art event category display boxes. In some embodiments consistent with the present invention images from a different related event may be substituted in the Category Highlight Display Boxes, if no images are associated with the highlighted event. In some embodiments consistent with the present invention, a News Attribute Display Box 770 may be used to display news of interest to the common interest community. For example, in FIG. 7B, a news article about a local symphony appears in the News Attribute Display Box 770.

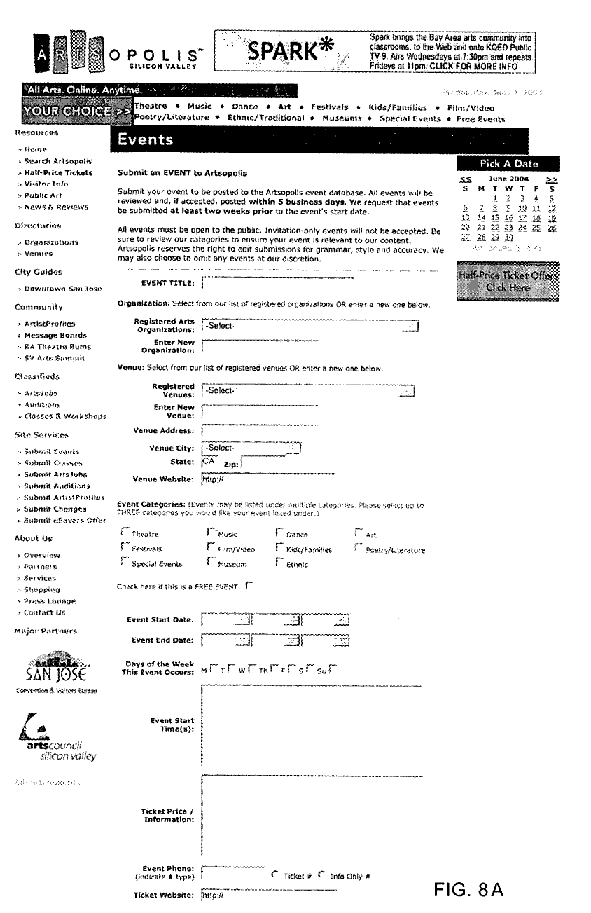

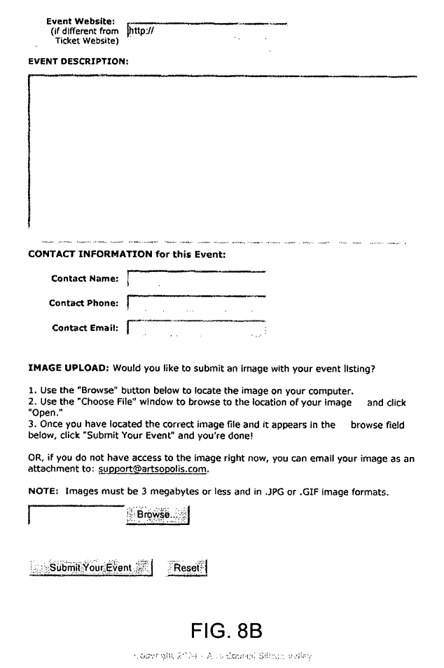

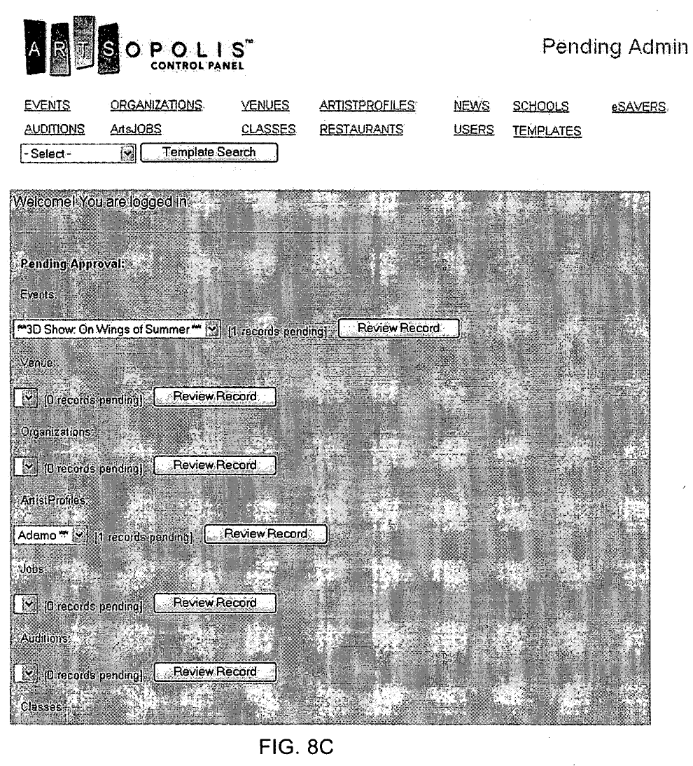

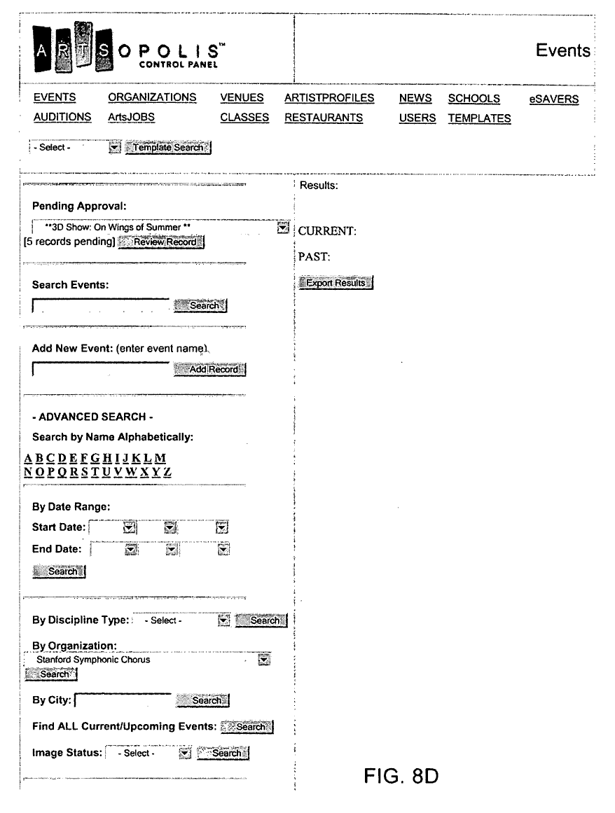

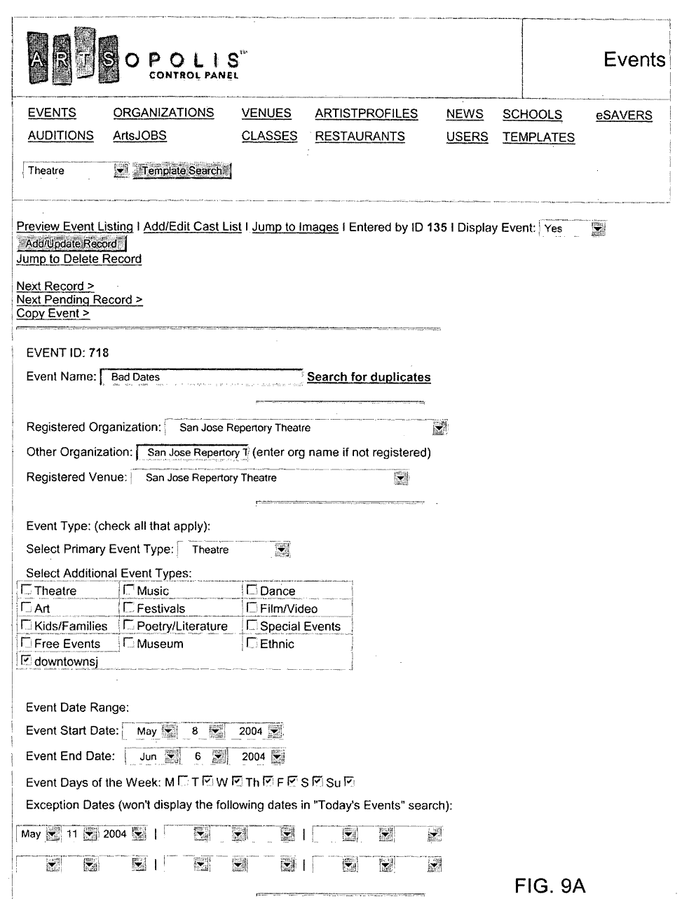

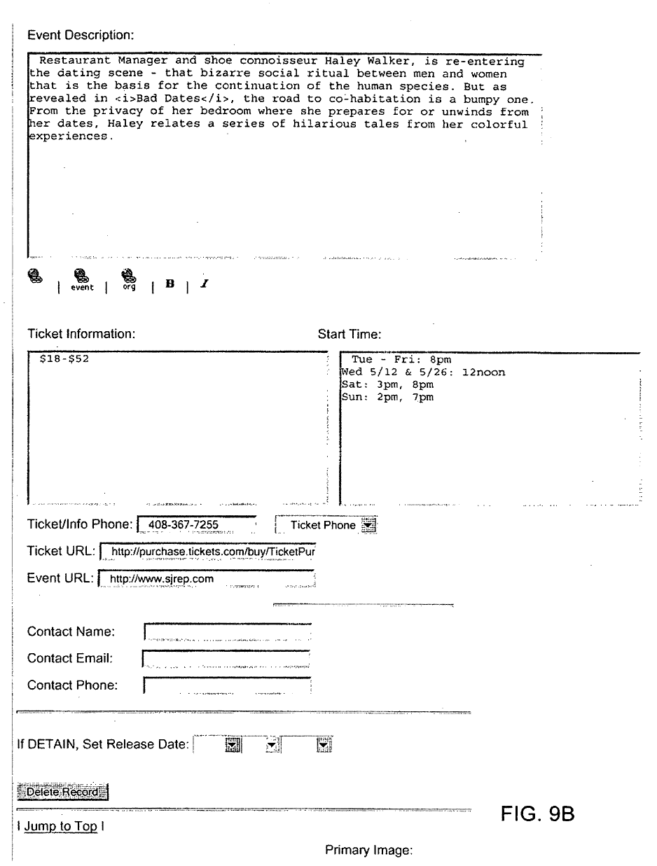

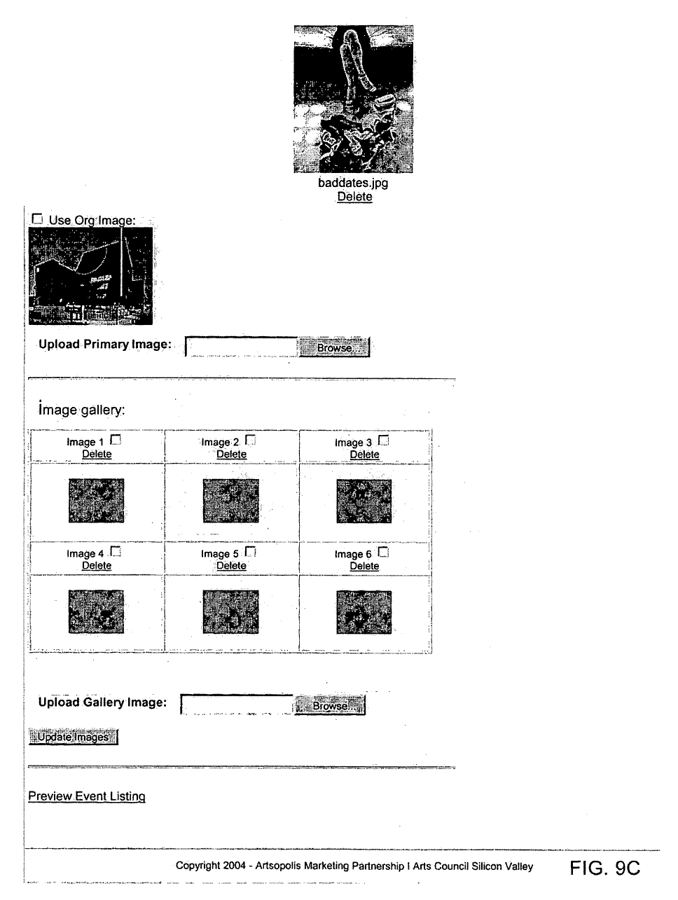

FIGS. 8A and 8B show an exemplary web page for Front End User Event Entry. In some embodiments consistent with the present invention, front end user event entry may be accomplished using an algorithm based on the flowchart of FIG. 3. The web page allows an end user to enter and/or select content related to an event including the event name and associated organizations and/or venues through a browser 140. In some embodiments consistent with the present invention, the end user may select from a list of pre-existing organizations that are stored in database 160. If an organization and/or venue are not listed in database 160, the end user may enter a new organization and/or venue. In some embodiments consistent with the present invention, selecting from the list of pre-existing organizations and/or venues will automatically generate links to the organization/venue information when the record is displayed to an end user. In some embodiments consistent with the present invention, an end user may associate categories with the event and enter additional information about the event including a description, date, and time information, contact information and information related to the purchase of tickets for the event. In some embodiments consistent with the present invention, as shown in FIG. 9B, an end user may upload an image to be associated with the event. Users may then submit the information for inclusion on an appropriate web page. In some embodiments consistent with the present invention, user submissions that pass integrity checks may be automatically reflected on the web page. In some embodiments consistent with the present invention, records may be kept pending following user submission for administrator review and approval.

FIG. 8C shows an exemplary web page that presents all pending front end user record submissions for approval by administrators. An administrator is presented with an overview of all pending records and may determine which content category requires greater attention. In some embodiments consistent with the present invention, the top of the page may include a header and links to the various content category administration pages. In some embodiments, a “Template Search” drop menu allows administrators to access functionality to manage the various event category types. In some embodiments consistent with the present invention, pending records may include both information submitted by end users via the public view of the Web site, and those records submitted by authorized Web site administrators using the administrative submission forms. For example, for an arts and cultural common interest community site pending records may include events, venues, organizations, individual artist profiles, and classified listings, such as jobs, audition and classes.

FIG. 8D shows an exemplary web page that presents all pending front end user record submissions for a particular event category for approval by administrators. Pending records may include both information submitted by end users via the front-end of the Web site, and records submitted by authorized Web site administrators using the event submission form via the administrative back end. As shown in FIG. 8D, the administrator may choose to view all pending records or search for pending events by specifying any of event name, date range, organization, geographic location or image status. Searches may be used to filter and locate duplicate records. In some embodiments consistent with the present invention, an administrator may export the search results to another file or application. In some embodiments consistent with the present invention, an administrator may choose to add or create a new event record by using the “add record” functionality provided on the web page.

FIGS. 9A, 9B, and 9C show an exemplary web page for back end administrative content entry that may be used for submitting and approving content listings. In some embodiments consistent with the present invention, portions of the back end content entry management system may be accomplished by an algorithm implementing steps such as in the exemplary flowchart of FIG. 4. In some embodiments consistent with the present invention, a menu presented to an administrator allows the final web pages to be previewed, links associated with the record to be edited, images to be uploaded and add other information related to the record being submitted. For example, in FIG. 9A, the displayed menu allows the cast list for a theatre submission to be edited, images related to the submission to be uploaded and allows an administrator to perform other housekeeping tasks related to the record. Once an event record is ready to be displayed to the end user, an administrator may allow display of the event, keep it pending or delete the record by making the appropriate menu selection. Additional menu choices allow an administrator to move sequentially between various types of records. Other selections on the web page allow an administrator to enter an event name, to search for duplicate records or associate registered organizations and/or venues with the event. In some embodiments consistent with the present invention, the association of a registered organization and/or venue with the event, links the organization's and/or the venue's directory record with the event record on the end user event display page. The administrator may also associate primary and additional category types to associate with an event and enter a date range. In some embodiments consistent with the present invention, days of the week on which the event will be performed may be specified. In some embodiments consistent with the present invention, dates when the event will not be performed may also be specified.

FIG. 9B shows a section of the exemplary web page for back end administrative content entry that may be used for submitting and approving content listings. In the exemplary web page that is shown, an event description along with ticket and contact information for the event may be entered. In some embodiments consistent with the present invention, a link to an electronic ticket vending application may be specified as part of the “Ticket URL”. In some embodiments consistent with the present invention a “Detain Feature” allows an administrator to enter an event record and then set a date for the event to be held until it's ready to be approved for display to the end user; for example, if an event occurs 9 months from its entry date and still requires more information, the administrator may choose to enter the event and then set a “reminder” date upon which the event will re-appear in the Pending Events list to be updated and approved.

FIG. 9C shows a section of the exemplary web page for back end administrative content entry that may be used for submitting and approving content listings. The web page presents a template for an administrator to enter and/or select data to be associated with an event. As shown in FIG. 9C, in some embodiments consistent with the present invention a primary image upload feature—allows the administrator to upload and associate an image to be associated with an event listing. In some embodiments consistent with the present invention image formats that may be associated include JPEG, GIF, and PING. If no images are associated with the event, only text information for that event will be displayed. In some embodiments consistent with the present invention, the administrator may specify that the image for another related event be displayed if no image is directly associated with the event. In some embodiments consistent with the present invention, if no unique event-specific graphic image is available to be uploaded to an individual event record the administrator may select the primary image associated with the presenting/producing organization's directory record, which may be the organization's photo or logo image. In some embodiments consistent with the present invention, an image gallery upload allows an administrator to upload up to six additional graphic images to be displayed in the “Image Gallery” section of the event's web page displayed to end users.

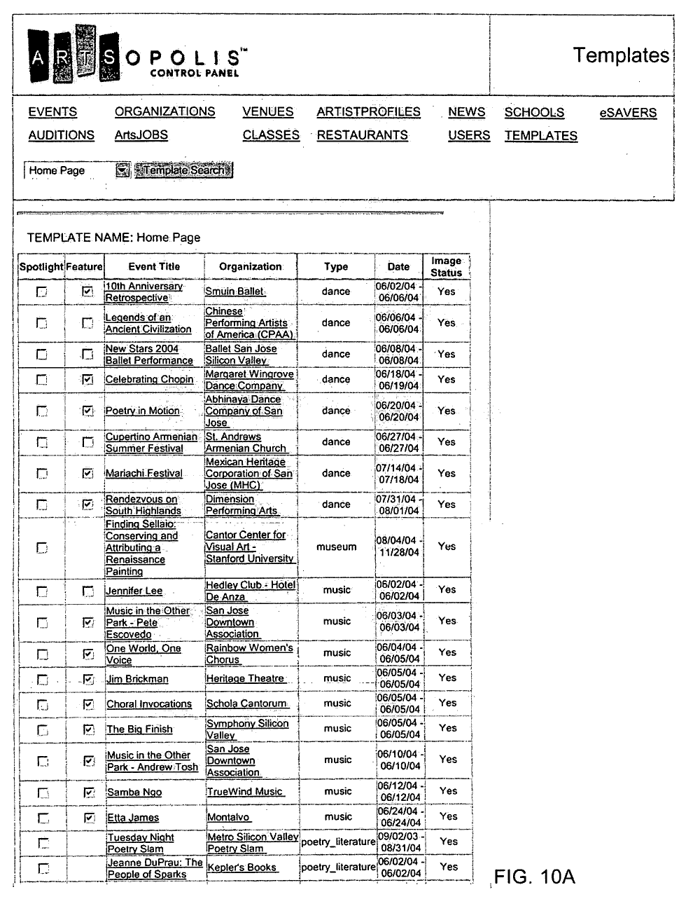

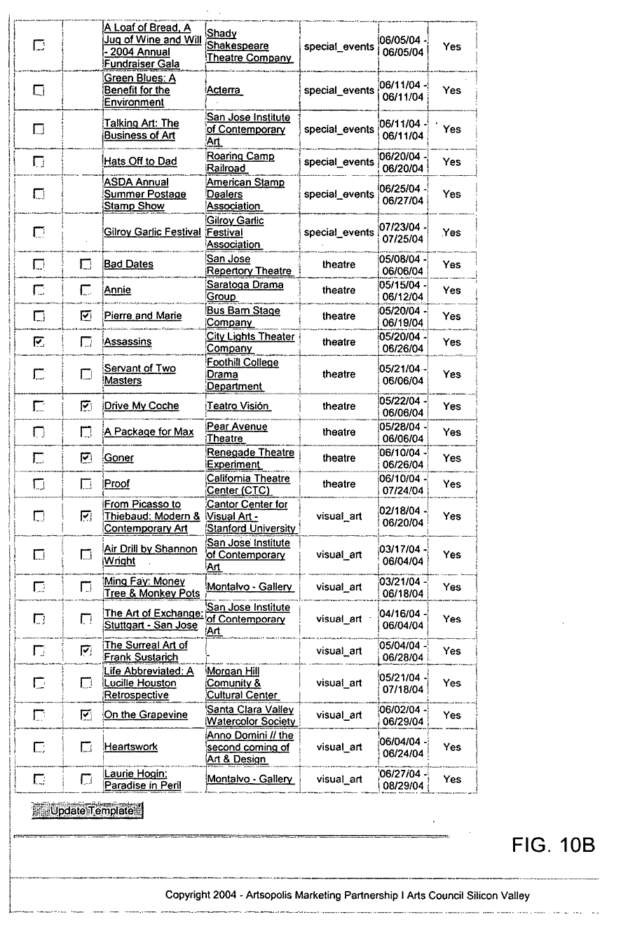

FIGS. 10A and 10B show a web page that serves as a template manager for a common interest community organization home page. As shown in FIG. 10A, immediately below the organization's logo, links are provided for an administrator to access templates for various categories. In some embodiments consistent with the present invention the administrator may select templates for various categories, including the home page. The web page displays the various events drawn from the set of events that have been selected as “Spotlight” or “Feature” events for their individual event categories. In some embodiments consistent with the present invention, displayed events may then be selected to be featured on the home page by checking the “Feature” box. An event may be spotlighted by checking the “Spotlight” box. For example, in FIG. 10B, the spotlight box for “Assassins” has been checked which causes the event and associated images and link to appear on the exemplary Artsopolis™ home page shown in FIG. 7B, in Spotlight Attribute Display Box 710.

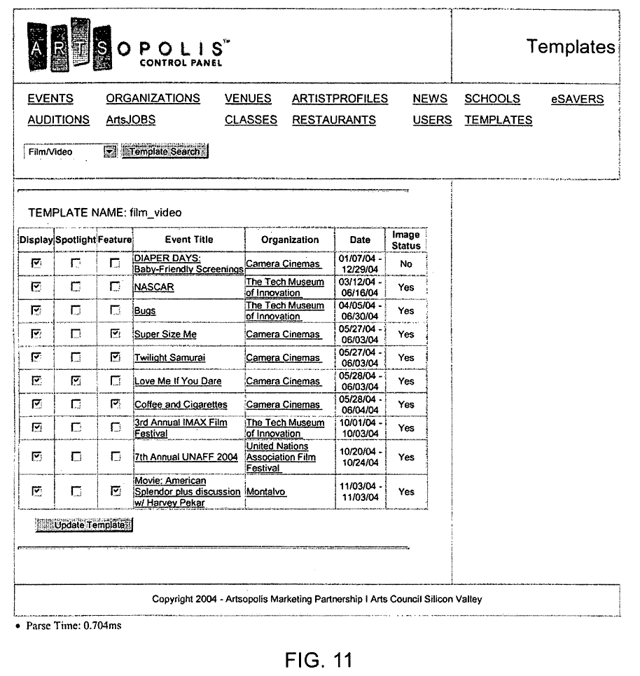

FIG. 11 shows an exemplary web page that serves as a template manager for an event category page. FIG. 11 shows the template manager for the Film/Video category page. As show in FIG. 11, the Category Template Manager displays all entered and approved events for a given event category type. In some embodiments consistent with the present invention, events may be set to display by default, upon approval by the administrator; however, unchecking the “Display” check box will prevent display of the event on the category web page. In some embodiments consistent with the present invention, a “Spotlight” check box allows for setting an event to appear in a Spotlight Attribute Display Box in the event category web page displayed to an end user. In some embodiments consistent with the present invention, more than one event can be selected for display in the spotlight section, although only one spotlight event will appear at any given time. In some embodiments consistent with the present invention, selected spotlight events may be rotated based on their chronological proximity. In some embodiments consistent with the present invention, if no events have been selected for the Spotlight section, then the chronologically closest event that appears first among the list of events displayed in the category template manager can be set to appear in the spotlight attribute display box. In some embodiments consistent with the present invention, the category template manager allows events to be “Featured” in a category highlight display box on the event category web page. In some embodiments consistent with the present invention, the administrator may specify up to seven events to appear in the category highlight section of the event category page displayed to the end user.

As shown in FIG. 11, the category template manager displays the title of each event and the names of any associated organizations. When a web page representing the event is displayed to a user, links to associated organizations will be automatically generated and displayed. In some embodiments consistent with the present invention an “Image Status” feature on the category template manager indicates whether an image has been associated with an event and allows the administrator to view the image associated with the link. In some embodiments consistent with the present invention, the web page associated with an event category will reflect changes made with the category template manager when the changes are confirmed by using an “Update Template” function provided on the category template manager web page.

Although embodiments of the present invention are described as being associated with programs stored in memory and other storage mediums, one skilled in the art will appreciate that these aspects can also be stored on, or read from, other types of computer-readable media, such as secondary storage devices, like hard disks, floppy disks, or CD-ROM; a carrier wave from the Internet; or other forms of RAM or ROM. Accordingly, the invention is not limited to the above-described embodiments, but instead may be defined by the appended claims in light of their full scope of equivalents. Additionally, the examples provided with this disclosure are provided for the purposes of illustration only and are not intended to be limiting.

Further, methods consistent with embodiments of the invention may conveniently be implemented using program modules, hardware modules, or a combination of program and hardware modules. Such modules, when executed, may perform the steps and features disclosed herein, including those disclosed with reference to the exemplary flow charts as shown in FIGS. 3, 4, and 5. The operations may be executed by the server or the clients or the functionality may be split between the clients and the server in a manner consistent with embodiments of the present invention. The operations, stages, and procedures described above and illustrated in the accompanying drawings are sufficiently disclosed to permit one of ordinary skill in the art to practice the invention. Moreover, there are many computers and operating systems that may be used in practicing embodiments of the instant invention and, therefore, no detailed computer program could be provided that would be applicable to these many different systems. Each user of a particular computer will be aware of the language, hardware, and tools that are most useful for that user's needs and purposes.

The above-noted features and aspects of the present invention may be implemented in various environments. Such environments and related applications may be specially constructed for performing the various processes and operations of the invention, or they may include a general-purpose computer or computing platform selectively activated or reconfigured by program code to provide the functionality. The processes disclosed herein are not inherently related to any particular computer or other apparatus, and aspects of these processes may be implemented by any suitable combination of hardware, software, and/or firmware. For example, various general-purpose machines may be used with programs written in accordance with teachings of the invention, or it may be more convenient to construct a specialized apparatus or system to perform the required methods and techniques.

Embodiments of the present invention also relate to computer—readable media that include program instructions or program code for performing various computer-implemented operations based on the methods and processes of embodiments of the invention. The program instructions may be those specially designed and constructed for the purposes of the invention, or they may be of the kind well known and available to those having skill in the computer software arts. Examples of program instructions include, for example, machine code, such as produced by a compiler, and files containing a high-level code that can be executed by the computer using an interpreter.

Other embodiments of the invention will be apparent to those skilled in the art from consideration of the specification and practice of the embodiments of the invention disclosed herein. It is intended that the specification and examples be considered as exemplary only, with a true scope and spirit of the invention being indicated by the following claims. As such, the invention is limited only by the following claims.

1. A method, comprising:
storing information regarding at least one activity of a community of common interest into a record of a database;
prioritizing the at least one activity for display;
composing a web page with the at least one activity; and
displaying the web page to a user.

2. The method of claim 1, wherein the information includes relationship information with other activities and related entities.

3. The method of claim 2, wherein the related entities includes one or more of a set consisting of sponsors, participants, venues, and organizations.

4. The method of claim 1, wherein prioritizing the at least one activity includes manually setting a priority for each of the at least one activity.

5. The method of claim 1, wherein prioritizing the at least one activity includes automatically setting a priority for each of the at least one activity.

6. The method of claim 1, wherein storing information comprises:
receiving information from a user;
creating a record containing the information;
searching the database for duplicate information;
verifying the information; and
entering the information into the database.

7. The method of claim 1, wherein storing information comprises creating a record containing the information into a record by a systems administrator and entering the record into the database.

8. The method of claim 1, wherein the information includes visual images.

9. The method of claim 8, wherein if a visual image is not entered for an activity, a visual image from a related record is substituted.

10. The method of claim 1, wherein storing information includes creating a record with partial information and suspending that record for a predetermined period of time before entry of remaining information for the record.

11. The method of claim 6, wherein creating a record containing the information comprises selecting from preexisting data in the database.

12. The method of claim 2, wherein the relationship information with other activities and related entities is selected from preexisting data in the database.

13. The method of claim 2, wherein the relationship information with other activities and related entities includes a banner or message associated with the activities or entities.

14. The method of claim 1, wherein composing the web page with the at least one activity comprises:
retrieving the record for the at least one activity;
retrieving files based on relationship information in the retrieved record;
creating hyperlinks between data in the record based on expressed associations in the record;
determining placement of items and links on the web page based on a template associated with the record;
generating the web page to be displayed.

15. The method of claim 14, wherein creating hyperlinks between data in the record based on expressed associations in the record includes links to external applications and web sites for electronic commerce activities.

16. A web system for a community of common interest comprising:
a computer with a database for:
storing information regarding at least one activity of a community of common interest into a record of a database;
prioritizing the at least one activity for display;
composing a web page with the at least one activity; and
displaying the web page to the user.

17. The system of claim 16, wherein the information includes relationship information with other activities and related entities.

18. The system of claim 17, wherein the related entities includes one or more of a set consisting of sponsors, participants, venues, and organizations.

19. The system of claim 16, wherein prioritizing the at least one activity includes manually setting a priority for each of the at least one activity.

20. The system of claim 16, wherein prioritizing the at least one activity includes automatically setting a priority for each of the at least one activity.

21. The system of claim 16, wherein storing information comprises:
receiving information from a user;
creating a record containing the information;
searching the database for duplicate information;
verifying the information; and
entering the information into the database.

22. The system of claim 16, wherein storing information comprises creating a record containing the information into a record by a systems administrator and entering the record into the database.

23. The system of claim 16, wherein the information includes visual images.

24. The system of claim 23, wherein if a visual image is not entered for an activity, a visual image from a related record is substituted.

25. The system of claim 16, wherein storing information includes creating a record with partial information and suspending that record for a predetermined period of time before entry of remaining information for the record.

26. The system of claim 21, wherein creating a record containing the information comprises selecting from preexisting data in the database.

27. The system of claim 17, wherein the relationship information with other activities and related entities is selected from preexisting data in the database.

28. The system of claim 17, wherein the relationship information with other activities and related entities includes a banner or message associated with the activities or entities.

29. The system of claim 16, wherein composing the web page with the at least one activity comprises:
retrieving the record for the at least one activity;
retrieving files based on relationship information in the retrieved record;
creating hyperlinks between data in the record based on expressed associations in the record;
determining placement of items and links on the web page based on a template associated with the record;
generating the web page to be displayed.

30. The system of claim 29, wherein creating hyperlinks between data in the record based on expressed associations in the record includes links to external applications and web sites for electronic commerce activities.

31. A computer processor executing instructions that perform steps in a method for managing a common interest community, the steps comprising:
storing information regarding at least one activity of a community of common interest into a record of a database;
prioritizing the at least one activity for display;
composing a web page with the at least one activity; and
displaying the web page to the user.

32. The processor of claim 31, wherein the information includes relationship information with other activities and related entities.

33. The processor of claim 32, wherein the related entities includes one or more of a set consisting of sponsors, participants, venues, and organizations.

34. The processor of claim 31, wherein prioritizing the at least one activity includes manually setting a priority for each of the at least one activity.

35. The processor of claim 31, wherein prioritizing the at least one activity includes automatically setting a priority for each of the at least one activity.

36. The processor of claim 31, wherein storing information comprises:
receiving information from a user;
creating a record containing the information;
searching the database for duplicate information;
verifying the information; and
entering the information into the database.

37. The processor of claim 31, wherein storing information comprises creating a record containing the information into a record by a systems administrator and entering the record into the database.

38. The processor of claim 31, wherein the information includes visual images.

39. The processor of claim 38, wherein if a visual image is not entered for an activity, a visual image from a related record is substituted.

40. The processor of claim 31, wherein storing information includes creating a record with partial information and suspending that record for a predetermined period of time before entry of remaining information for the record.

41. The processor of claim 36, wherein creating a record containing the information comprises selecting from preexisting data in the database.

42. The processor of claim 32, wherein the relationship information with other activities and related entities is selected from preexisting data in the database.

43. The processor of claim 31, wherein the relationship information with other activities and related entities includes a banner or message associated with the activities or entities.

44. The processor of claim 31, wherein composing the web page with the at least one activity comprises:
retrieving the record for the at least one activity;
retrieving files based on relationship information in the retrieved record;
creating hyperlinks between data in the record based on expressed associations in the record;
determining placement of items and links on the web page based on a template associated with the record;
generating the web page to be displayed.

45. The processor of claim 44, wherein creating hyperlinks between data in the record based on expressed associations in the record includes links to external applications and web sites for electronic commerce activities.

46. A processing environment comprising:
means for storing a relational information record regarding at least one activity of a community of common interest;
means for according a priority to the at least one activity;
means for composing a web page with the at least one activity; and
means for displaying the web page to a user.

47. The processing environment of claim 46, wherein the relational information record includes relationship information with other activities and related entities.

48. The processing environment of claim 47, wherein the related entities includes one or more of a set consisting of sponsors, participants, venues, and organizations.

49. The processing environment of claim 46, wherein means for storing a relational information record comprises:
means for receiving information from users;
means for verifying the received information;
means for creating a relational information record including the received information;
means for ensuring the uniqueness of the relational information record; and
means for entering the information into the database.

50. The processing environment of claim 49, wherein the received information from users includes images and other multimedia content.

51. The processing environment of claim 49, wherein the relational information record may be include content from other preexisting stored information

52. The processing environment of claim 49, wherein means for composing the web page with the at least one activity comprises:
means for retrieving the relational information record for the at least one activity;
means for retrieving other information based on information in the relational information record;
means for dynamically creating hyperlinks between data in the relational information record based on expressed associations in the record;
means for dynamically determining placement of items and links on the web page based on a template associated with the record; and
means for generating the web page to be displayed.

53. A web site management system comprising:
a computer-readable medium that stores instructions, which when executed by a computer perform steps in a method for managing a common interest community, the steps comprising:
storing information regarding at least one activity of a community of common interest into a record of a database;
prioritizing the at least one activity for display;
composing a web page with the at least one activity; and
displaying the web page to the user.
